(19) United States
(12) Patent Application Publication
(10) Pub. No.: US 2025/0363551 A1
(43) Pub. Date: Nov. 27, 2025

(54) ON-DEMAND GAMING ESTABLISHMENT RETAIL ACCOUNT CREATION

(71) Applicant: IGT, Las Vegas, NV (US)

(72) Inventors: Jeffery Shepherd, Reno, NV (US); Kevin Higgins, Reno, NV (US)

(21) Appl. No.: 18/670,225

(22) Filed: May 21, 2024

(51) Int. Cl. G06Q 40/02; G06Q 20/10

(52) U.S. Cl. CPC G06Q 40/02; G06Q 20/10

(57) ABSTRACT

Systems and methods that enable the automatic creation of a gaming establishment retail account based on a requested retail transaction and which employs data from an existing gaming establishment account.

### BACKGROUND

In various embodiments, the systems and methods of the present disclosure enable the automatic creation of a gaming establishment retail account based on a requested retail transaction and which employs data from an existing gaming establishment account.

Casinos are associated with multiple different channels of commerce including gaming activities (e.g., wagers on plays of games at electronic gaming machines and gaming tables) and non-gaming activities (e.g., making retail purchases at point-of-sale terminals throughout the casino).

### BRIEF DESCRIPTION OF THE SEVERAL VIEWS OF THE DRAWINGS

FIG. 1 is an example configuration of the architecture of a plurality of different components of the system of the present disclosure.

FIG. 2 is a flow chart of an example process for operating a system including determining if a gaming establishment retail account exists in association with a requested gaming establishment retail transaction and if not, creating such a gaming establishment retail account to facilitate a completion of the gaming establishment retail transaction.

FIGS. 3A, 3B and 3C are flow charts of example processes for operating a system including various components that operate to create a gaming establishment retail account in association with a gaming establishment retail transaction and to modify one or more attributes of the created gaming establishment retail account based on data obtained from one or more of such components.

FIG. 4 is a flow chart of an example process for operating a system including various components that operate to bulk load funds to a gaming establishment retail account in anticipation of a potential use of such funds.

FIG. 5 is a flow chart of an example process for operating a system including various components that operate to increase an amount of funds of a gaming establishment retail account in association with a gaming establishment retail refund transaction and to periodically sweep such funds from the gaming establishment retail account to another gaming establishment account.

### DETAILED DESCRIPTION

In various embodiments, the systems and methods of the present disclosure enable the automatic creation of a gaming establishment retail account based on a requested retail transaction and which employs data from an existing gaming establishment account.

In certain embodiments, the system of the present disclosure creates a gaming establishment retail account to be maintained by a gaming establishment fund management system in association with an attempted retail transaction, such as an attempted retail purchase transaction at a point-of-sale terminal of a gaming establishment retailer. In these embodiments, since certain regulations dictate that a relatively extensive set of data must be collected from a user (and certain other tasks must be undertaken by the user) to create a first gaming establishment account, such as a cashless wagering account for that user, but less data is required to be collected (and other tasks need not be undertaken by the user) to create a gaming establishment retail account for that user, responsive to a user without a gaming establishment retail account attempting to engage in a gaming establishment retail transaction, the system enables the on-demand creation of a gaming establishment retail account. Such an automatic creation of a gaming establishment retail account occurs in association with an initial attempted gaming establishment retail transaction and without requiring the user to provide certain information and/or undertake certain tasks otherwise associated with creating other gaming establishment accounts. In these embodiments, as part of (and/or subsequent to) completing a retail transaction in association with a created gaming establishment retail account, the system utilizes certain data from one or more existing gaming establishment accounts, such as a cashless wagering account and/or a gaming establishment patron management system account, in the creation (or subsequent augmentation) of the gaming establishment retail account. The system thus eliminates the redundancy in a user submitting the same information repeatedly and performing the same task repeatedly to create different gaming establishment accounts. Automatically creating, when needed, a gaming establishment retail account based on data previously procured from a user in association with enrolling in another gaming establishment account saves users time in not having to separately sign up for multiple accounts individually and increases efficiency of the gaming establishment systems tasked with opening these various accounts by not dedicating processing resources to having to open certain gaming establishment retail accounts prior to being needed (and, in certain instances, not dedicating storage resources to save the same information in multiple databases).

More specifically, given the relatively small amount of data (e.g., a user's name and contact information) certain jurisdictions require to create a gaming establishment retail account, the system enables the on-demand creation of a gaming establishment retail account when the user initially exhibits a need for such a gaming establishment retail account. That is, rather than requiring a user to pre-create a gaming establishment retail account for future use, the system enables a user without a gaming establishment retail account to bypass such a step because the system creates a gaming establishment retail account when needed to complete a gaming establishment retail transaction. In these embodiments, following the on-demand creation of a gaming establishment retail account in association with an attempted gaming establishment retail transaction, the system operates to transfer funds from an existing gaming establishment account, such as a cashless wagering account, to the gaming establishment retail account (and then potentially to an account of a gaming establishment retailer) to facilitate the gaming establishment retail transaction.

In certain embodiments, in anticipation of one or more subsequent gaming establishment retail transactions associated with the created gaming establishment retail account, the amount of funds transferred from the existing gaming establishment account to the created gaming establishment retail account exceed the amount of funds needed to complete the gaming establishment retail transaction. In these embodiments, since the funds transferred to an account of a gaming establishment retailer to complete a purchase transaction may first have to be transferred from a cashless wagering account to the created gaming establishment retail account and then from the gaming establishment retail account to the account of the gaming establishment retailer, transacting against the cashless wagering account for each purchase made by a user during a user's visit to a gaming establishment would potentially exponentially increase the computational load placed on the system. Put differently, while certain systems are configured to handle the operational load of the relatively infrequent transfers between a gaming establishment retail account and an intermediary gaming establishment account, such as a cashless wagering account (to facilitate a gaming establishment retail transaction), if such systems were forced to conduct such transactions relatively frequently, the load created on the system would potentially compromise or degrade certain aspects of the system. Accordingly, in anticipation of the relatively high quantity of gaming establishment retail transactions occurring during a relatively short period of time (e.g., during a user's planned trip to a gaming establishment) and given the operational load each gaming establishment retail transaction requires, the system of certain embodiments the present disclosure reduce the load introduced by such frequent retail transactions by employing the created gaming establishment retail account to hold an amount of funds (for the relatively short period of time) that exceeds the immediate need for such an amount of funds. That is, in certain instances, the system rounds up the amount of funds transferred to the created gaming establishment retail account such that the excess amount of funds may be deployed in association with one or more subsequent gaming establishment retail transactions involving the created gaming establishment retail account.

In certain such embodiments, following the creation of a gaming establishment retail account based on a first requested retail transaction, the system utilizes the gaming establishment retail account to accumulate funds from one or more other gaming establishment accounts and escrow such funds prior to use. In these embodiments, given the excessive infrastructure load introduced by relatively high frequency transactions against such other gaming establishment accounts (and the corresponding limits to scalability of the system due to such excessive infrastructure loads), the system alleviates such excessive infrastructure loads on the overall system by anticipating future retail transactions and transfers an amount of funds to the created gaming establishment retail account in anticipation of the need of such funds. In other words, to mitigate the load placed upon the other gaming establishment accounts associated with the system, the system automatically bulk-loads funds into the gaming establishment retail account for a period of time. In such embodiments, following the period of time during which the system bulk-loads funds into the created gaming establishment retail account (and/or following a transfer of an amount of funds to the created gaming establishment retail account in association with a return transaction), the system proceeds to transfer such funds (e.g., any unused funds from the bulk transfer and/or any funds attributed to the return transaction) to one or more gaming establishment accounts (and/or one or more external accounts maintained independent of the system).

It should be appreciated that by bulk-loading the gaming establishment retail account with funds anticipated to be used and then transacting against the gaming establishment retail account on a per transaction basis, the system does not need to transact against other gaming establishment accounts maintained by the system (and/or one or more external accounts maintained independent of the system) to first transfer funds to the gaming establishment retail account and then to transact against the individually funded gaming establishment retail account per transaction (therefore reducing the load created on the system). Such a configuration of automatically transferring funds from various gaming establishment accounts to a gaming establishment retail account in anticipation of certain retail activity additionally reduces the number of account balance queries associated with the system since part or all of an amount of funds projected to be used for the anticipated retail activity will reside, by design, in the gaming establishment retail account. As such, employing the gaming establishment retail account to periodically hold certain amounts of funds increases the efficiency of the system by reducing the amount of fund transfers needed in association with the gaming establishment retail account to complete multiple gaming establishment retail transactions.

In certain embodiments, rather than transferring an excess amount of funds to the gaming establishment retail account, the amount of funds transferred from the existing gaming establishment account to the created gaming establishment retail account match the amount of funds needed to complete the gaming establishment retail transaction such that the created gaming establishment retail account does not otherwise hold any amounts of funds. In these embodiments, if multiple gaming establishment retail transactions are not anticipated (e.g., the user is not currently staying at a hotel associated with the gaming establishment), the system transfers the requested amount of funds to the created gaming establishment retail account without bulk-loading any additional funds for future anticipated uses. Such embodiments increase the efficiency of the system by reducing the amount of accounts associated with a gaming establishment that actively hold funds (which are associated with various reporting requirements and one or more corresponding backing accounts) as well as reducing instances of the above-described need (and thus avoid the associated operational load placed on the system) to return or otherwise sweep any unused funds from the created gaming establishment retail to other gaming establishment accounts (and/or one or more external accounts maintained independent of the system).

In certain embodiments, the employment of an automatically created gaming establishment retail account to facilitate one or more gaming establishment retail transactions by enabling such a gaming establishment retail account to be utilized to transfer funds to one or more gaming establishment retail verticals realizes various benefits via the reduction (or elimination) of the use of cash in a gaming establishment environment. For example, since certain gaming establishment patrons are uncomfortable venturing into a gaming establishment with large amounts of cash, the system enables a user access to an amount of funds to make gaming establishment retail purchases (via the automatically created gaming establishment retail account) without the need to handle cash. Such reduction in the use of cash at a gaming establishment provides a relatively more secure environment for a user (via reducing or eliminating a user carrying cash on their person and thus diminishing the risks that such cash may be lost or stolen), overcomes various health concerns associated with cash-based transactions and cashless ticket voucher-based transactions (e.g., protecting patrons from using forms of currency and/or paper cashless ticket vouchers that act as transmission vehicles for contagions), and benefits the gaming establishment by reducing the use of certain kiosks that accept and dispense cash (e.g., reducing the wear and tear on such devices and prolonging the operational life on these devices).

Additionally, by reducing the amount of cash transactions in a gaming establishment via enabling the automatic enrollment in a gaming establishment retail account, the system reduces or eliminates human errors which often occur when cash is distributed at gaming establishment interfaces. Specifically, eliminating gaming establishment personnel from distributing cash (to be used to make gaming establishment retail purchases) in exchange for one or more redeemed ticket vouchers (if the gaming establishment personnel provides the gaming establishment patron a lower amount of cash than the patron deserves) but also protects the gaming establishment (if the gaming establishment personnel inadvertently or fraudulently provides the patron a higher amount of cash than the patron deserves). As such, the system of the present disclosure provides an alternative, non-cash-based and non-ticket voucher-based option for a gaming establishment patron to access funds at one or more gaming establishment retail locations without having to undertake the creation of any accounts prior to usc.

In various embodiments, the present disclosure is directed to a system including or otherwise in communication with various components and/or sub-systems that operate together to cause a creation of a gaming establishment retail account when needed and based certain data previously associated with one or more other gaming establishment accounts, such as a cashless wagering account and/or a player tracking account (i.e., a gaming establishment patron management system account). In these embodiments, the collection of components that are part of the system (or otherwise operate with one or more components of the system) further enable the transfer of funds between different accounts associated with a user (including, in certain instances, the created gaming establishment retail account) and/or the transfer of funds between a gaming establishment account associated with a user (including, in certain instances, the created gaming establishment retail account) and an account associated with a gaming establishment retail establishment.

In certain embodiments, the present disclosure is directed to a gaming establishment fund management system including various sub-systems that are each associated with or otherwise maintain one or more electronic or virtual accounts. In these embodiments, the various accounts maintained for a user collectively form a resort or enterprise account (i.e., a gaming establishment fund management account) for the user. That is, the collection of cashless wagering accounts (e.g. cashless gaming establishment wagering wallets, cashless sports wagering wallets and/or cashless mobile wagering wallets) and gaming establishment retail accounts (e.g., gaming establishment retail wallets) associated with or otherwise maintained for a user individually and/or collectively form a resort or enterprise account (i.e., an integrated resort or gaming establishment fund management wallet) that the user may access to transfer funds and/or view balance information amongst the various accounts associated with or otherwise maintained for the user.

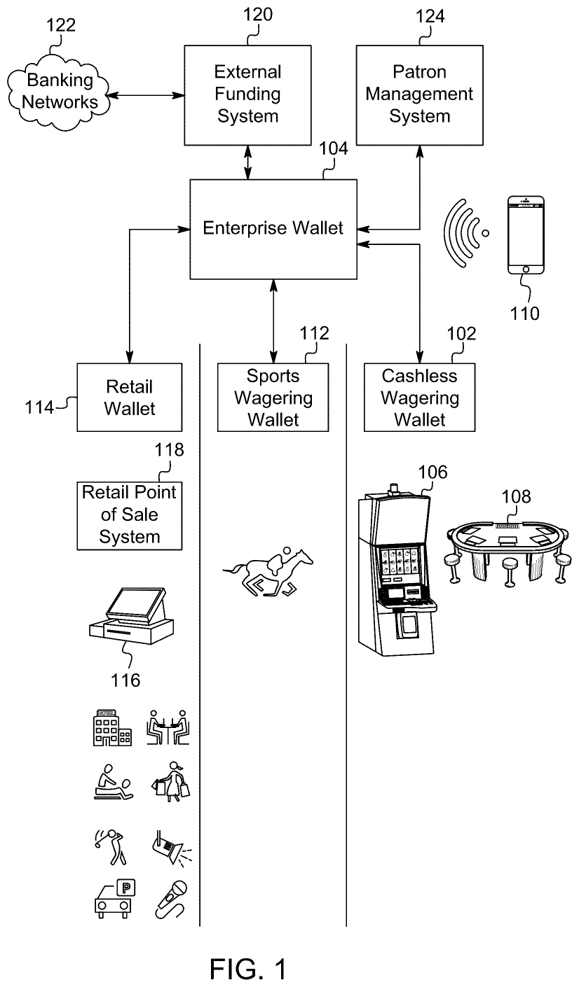

In various embodiments, the gaming establishment fund management system includes or is otherwise associated with one or more cashless wagering systems. Each cashless wagering system is associated with or otherwise maintain one or more cashless wagering accounts. In certain embodiments, the gaming establishment fund management system includes or is otherwise in communication with a first cashless wagering system that maintains a first cashless wagering account. In these embodiments, a user, such as a player of an electronic gaming machine (“EGM”), utilizes a mobile device application running on a mobile device and/or a physical instrument (e.g., a smart card or a user issued magnetic striped card which the user utilizes via inserting the card into a component of a gaming establishment patron management system associated with a gaming establishment device) to facilitate the electronic transfer of any funds between this first cashless wagering account and a gaming establishment device, such as a component of a gaming table and/or an EGM (including, but not limited to, a slot machine, a video poker machine, a video lottery terminal, a terminal associated with an electronic table game, a terminal associated with a live table game, a video keno machine, a video bingo, and/or a sports betting terminal (that offers wagering games and/or sports betting opportunities)). For example, as seen in FIG. 1, the gaming establishment fund management system includes a first cashless wagering system (not shown) that maintains a Cashless Wagering Wallet 102 (e.g., a first cashless wagering account) which is in communication with the enterprise wallet 104. In this example, to facilitate the transfer of funds between this cashless wagering account and a credit balance of an EGM 106 and/or a credit balance of a gaming table component (not shown) associated with a gaming table 108, the system utilizes a mobile device 110 running a mobile device application that interfaces with one or more components of the gaming establishment fund management system to enable a user, such as a player of the EGM or a player at the gaming table, access to this first cashless wagering account.

In certain embodiments, the gaming establishment fund management system additionally or alternatively includes or is otherwise in communication with a second cashless wagering system that maintains a second cashless wagering account. In these embodiments, funds associated with the second cashless wagering account are utilized to place one or more sporting event wagers and/or wagers placed remote from an EGM and a gaming table. In such embodiments, a user utilizes a mobile device application running on a mobile device and/or a physical instrument (e.g., a smart card or a user issued magnetic striped card which the user utilizes via inserting the card into a kiosk) to facilitate the electronic transfer of any funds between this second cashless wagering account and a credit balance accessible to wager on sporting events and/or games of chance (or games of skill) remote from an EGM and a gaming table. For example, as seen in FIG. 1, the gaming establishment fund management system includes a second cashless wagering system (not shown) that maintains a Sports Wagering Wallet 112 (e.g., a second cashless wagering account) which is in communication with the enterprise wallet 104. In this example, to facilitate the transfer of funds between this cashless wagering account and a credit balance associated with a sporting event wagering system (not shown) and/or a remote wagering system (not shown) to enable the placement of one or more wagers on one or more sporting events and/or one or more games of chance (or games of skill), the system utilizes a mobile device 110 running a mobile device application that interfaces with one or more components of the gaming establishment fund management system to enable, amongst other activities, a user, such as a user remote from the gaming establishment, access to this second cashless wagering account.

In various embodiments, in addition to or an alternative of maintaining one or more cashless wagering accounts via one or more cashless wagering systems, the gaming establishment fund management system includes or is otherwise in communication with one or more gaming establishment retail wallet systems that each maintain one or more gaming establishment retail accounts. In certain instances, the system creates such a gaming establishment retail account in association with an initial gaming establishment retail transaction that could utilize the involvement of a gaming establishment retail account. Whether the gaming establishment retail account is created on-demand or prior to an initial gaming establishment retail transaction, such a gaming establishment retail account (e.g., a gaming establishment retail wallet) of a gaming establishment retail wallet system integrates with various retail point-of-sale systems throughout the gaming establishment (or located remote from the gaming establishment, but otherwise associated with the gaming establishment) to enable users to purchase goods and/or services via the user's gaming establishment retail account. For example, as seen in FIG. 1, the gaming establishment fund management system includes a gaming establishment retail wallet system (not shown) that maintains a Retail Wallet 114 (e.g., a gaming establishment retail account) which is in communication with the enterprise wallet 104. In this example, to facilitate the transfer of funds between this gaming establishment retail account and an account associated with a retailer to purchase goods and/or services from the retailer, the system utilizes a retail wallet identity, such as a mobile device 110 running a mobile device application that interfaces with a point-of-sale terminal 116 of a retail point-of-sale system 118 of the retailer and/or a physical instrument (e.g., a smart card or a user issued magnetic striped card which the user utilizes in association with the point-of-sale terminal), and one or more components of the gaming establishment fund management system to enable a user access to this gaming establishment retail account. In different embodiments, the gaming establishment retail account is operable to hold different types of instruments exchangeable for goods and/or services, such as, but not limited to, an amount of monetary funds, an amount of non-monetary funds (e.g., non-cashable promotional credits, promotional credits) and/or one or more coupons. In certain embodiments, the gaming establishment fund management system utilizes the gaming establishment retail wallet system as a transaction coordinator to account for any transactions to purchase goods and/or services from a retailer.

In certain embodiments, a gaming establishment retail account is a retail account associated with a user having a balance or a pre-paid access account which, per current regulations from the U.S. Treasury Department Financial Crimes Enforcement Network (“FinCEN”), cannot be convertible to cash and can only be used for the purchase of goods and/or services. In these embodiments, such a gaming establishment retail account integrates with various retail point-of-sale systems of various retail establishments throughout or otherwise associated with a gaming establishment to enable users to purchase goods and/or services via the user's gaming establishment retail account. Accordingly, in certain embodiments, based on one or more jurisdictional regulations, an amount of funds deposited in a gaming establishment retail account may be used with various retail point-of-sale systems throughout the gaming establishment (or remote from, but otherwise associated with the gaming establishment) to enable users to purchase goods and/or services, but such funds deposited in the gaming establishment retail account cannot be converted to cash or check. In certain other embodiments, based on one or more different jurisdictional regulations, an amount of funds deposited in a gaming establishment retail account, such as an account associated with an identified user, may be used with various retail point-of-sale systems throughout the gaming establishment (or remote from, but otherwise associated with the gaming establishment) to enable users to purchase goods and/or services wherein such funds deposited in the gaming establishment retail account may be converted to or otherwise redeemable for cash or check.

In various embodiments, the system includes or is otherwise in communication with a payment gateway operable to interface with a banking network to communicate with one or more servers of one or more financial institutions that maintain one or more financial institution accounts and implement zero, one or more financial institution protocols, such as banking protocols. In such embodiments, the system includes a payment gateway operable with a banking network and one or more external funding sources (e.g., financial institutions) which maintain one or more external accounts (e.g., financial institution accounts) for a user to enable certain actions, including, but not limited to, balance inquiries, funding source enrollments and/or fund transfers. For example, as seen in FIG. 1, the gaming establishment fund management system that maintains the enterprise wallet 104 is in communication with a payment gateway (i.e., external funding system 120) which is in communication with a network of one or more banks or other financial institutions (i.e., the banking networks 122) which operate to electronically transfer funds between the user's accounts maintained at such banks or financial institutions between one or more of the accounts maintained by the gaming establishment fund management system. In different embodiments, the accounts of the external funding sources include, but are not limited to, one or more checking accounts maintained by one or more financial institutions (e.g., one or more banks and/or credit unions), one or more savings accounts maintained by one or more financial institutions, one or more financial institution accounts, such as a brokerage account, maintained by one or more financial institutions, one or more credit card accounts maintained by one or more financial institutions, one or more debit card accounts maintained by one or more financial institutions, and/or one or more third-party maintained accounts (e.g., one or more PayPal® accounts or Venmo® accounts). It should be appreciated that any component or sub-system of the present disclosure can be in communication with one or more external funding sources. In different embodiments, the system utilizes a mobile device running a mobile device application, a kiosk, a gaming device (e.g., an interface of an EGM or gaming table component), a service window displayed by a gaming device (e.g., a remote host controlled service window displayed by an EGM), a component of a gaming establishment patron management system, such as a player tracking unit, and/or a gaming establishment interface to facilitate the transfer of funds to/from an external account.

In certain embodiments, the gaming establishment fund management system includes or is otherwise in communication with one or more gaming establishment patron management systems, such as one or more player tracking systems, that maintain data associated with one or more users, monitor activities at various points of contact associated with the gaming establishment and provides rewards, such as redeemable player tracking points, to such users in association with the monitored activities. For example, as seen in FIG. 1, the gaming establishment fund management system that maintains the enterprise wallet 104 is in communication with a patron management system 124 which maintains one or more databases including information regarding gaming establishment patrons. It should be appreciated that any component or sub-system of the present disclosure can be in communication with one or more gaming establishment patron management systems. In different embodiments, the system utilizes a mobile device running a mobile device application, a kiosk, an interface of a gaming device (e.g., an interface of an EGM or gaming table component), a service window displayed by a gaming device (e.g., a remote host controlled service window displayed by an EGM), a component of a gaming establishment patron management system, such as a player tracking unit, and/or a gaming establishment interface to interface with the gaming establishment patron management system.

In certain embodiments, the gaming establishment fund management system includes or is otherwise in communication with one or more credit systems which each issue the user one or more lines of credit or markers. In certain embodiments, these lines of credit or markers are accessible to facilitate a transfer of funds from the line of credit issued by the credit system to, either directly or indirectly through a cashless wagering account, a credit balance of a gaming establishment device, such as an EGM and/or a gaming table. In this example, to facilitate a transfer of funds from the line of credit issued by the credit system to a credit balance of an EGM and/or a gaming table, the system utilizes a mobile device running a mobile device application that interfaces with one or more components of the credit system to enable a user, such as a player of the EGM or a player at the gaming table, access to the issued line of credit. In certain embodiments, these lines of credit or markers are additionally or alternatively accessible to facilitate a transfer of funds from the line of credit issued by the credit system to, cither directly or indirectly through a cashless wagering account, a balance of a gaming establishment retail account to facilitate a gaming establishment retail transaction. It should be appreciated that in different embodiments, the system utilizes a mobile device running a mobile device application, a kiosk, a gaming device (e.g., an interface of an EGM or gaming table component), a service window displayed by a gaming device (e.g., a remote host controlled service window displayed by an EGM), a component of a gaming establishment patron management system, such as a player tracking unit, and/or a gaming establishment interface to interface with the gaming establishment credit system.

In certain embodiments, the gaming establishment fund management system includes or is otherwise in communication with one or more credit reporting/credit risk systems which monitor and report on various accounts associated with the user. These credit reporting and risk systems monitor and report on a credit rating and status of one or more accounts maintained for the user at various funding sources, such as various financial institutions.

In certain embodiments, the gaming establishment fund management system includes or is otherwise in communication with one or more front money handling systems which each maintain an amount of front money provided by a user in a front money account. For example, the gaming establishment fund management system that maintains the enterprise wallet is in communication with a gaming establishment front money handling system to facilitate the access of an amount of funds via front money provided by the user. Such front money is provided by the user, such as via the user depositing cash, gaming table chips, a personal check, a bank draft, a money order or a wire transfer into a front money account associated with the user. The balance of the front money is drawn down from the front money account (in certain instances via the issuance of markers) and accessible by the front money handling system to (either directly or indirectly through a cashless wagering account) a credit balance of a gaming device, such as an EGM and/or a gaming table and/or to (either directly or indirectly through a gaming establishment retail account) a point-of-sale terminal (or an account associated with the point-of-sale terminal).

In certain embodiments, the system utilizes one mobile device application to interact with the different components of (or in communication with) the gaming establishment fund management system to, amongst other actions, access funds maintained in the different gaming establishment accounts associated with the user. For example, utilizing the same mobile application, a mobile device interacts with both the first cashless wagering system of the gaming establishment fund management system and the gaming establishment retail wallet system of the gaming establishment fund management system. In certain embodiments, the system utilizes multiple mobile device applications to interact with the different components of (or in communication with) the gaming establishment fund management system to, amongst other actions, access funds maintained in the different gaming establishment accounts associated with the user. In certain of these embodiments, the mobile device applications include a location based digital wallet enabled application, such as a Passbook-enabled or Wallet-enabled application, which is accessible when the user enters a gaming establishment. In certain of such embodiments, the mobile device applications are downloaded to the mobile device from an application store. In certain of such embodiments, the mobile device applications are downloaded to the mobile device from one or more websites affiliated with the gaming establishment (which are accessible directly by the user and/or by a link opened when the user scans a QR code).

In certain embodiments, to interact with one or more components of (or in communication with) the system, the system enables a user to pair or link their mobile device to a gaming establishment device, such as a gaming device (e.g., an EGM) or a non-gaming device (e.g., a point-of-sale terminal). In these embodiments, the pairing or linkage between the mobile device and the gaming establishment device occurs via one or more applications being run or executed on the mobile device. In certain such embodiments, the mobile device application prompts the user to cause the mobile device to engage the gaming establishment device or a component of the gaming establishment device (e.g., a slot machine interface board (“SMIB”) or other component of a gaming establishment management system supported by an EGM). After any required engagement, the mobile device application communicates, via a wireless communication protocol (including, but not limited to: Bluetooth™, Bluetooth™ Low Energy (“BLE”), one or more cellular communication standards (e.g., 3G, 4G, 5G, 6G, LTE), one or more Wi-Fi compatible standards, and one or more short range communication protocols (e.g., a near field communication (“NFC”) protocol), data associated with a requested action. Following the mobile device application communicating, via a wireless communication protocol, data associated with a requested action, the gaming establishment device (or a component of the gaming establishment device and/or the mobile device application) proceeds with operating with a component of (or in communication with) the gaming establishment fund management system to log the user into an account maintained by that component (if necessary) and request authorization of the requested action.

It should be appreciated that in different embodiments, in addition to or alternatively from utilizing a mobile device running a mobile device application to facilitate the completion of one or more actions, the system utilizes a kiosk, a gaming device (e.g., an interface of an EGM or gaming table component), a service window displayed by a gaming device (e.g., a remote host controlled service window displayed by an EGM), a display device/input device associated with a seat-level gaming table component, a display device/input device associated with a table-level gaming table component, a display device/input device associated with a mobile gaming table component, a component of a gaming establishment patron management system, such as a player tracking unit, a retail point-of-sale terminal, and/or a gaming establishment interface, such as a casino desk, to facilitate the completion of one or more actions. It should be further appreciated that while illustrated in FIG. 1 as using a mobile device running a mobile device application to enable a user access to the system, as mentioned above, a physical instrument, such as a smart card or a user issued magnetic striped card may additionally or alternatively be utilized to enable a user such access. It should also be appreciated that two or more of the systems, sub-systems and components of the present disclosure may be combined into a single system, sub-system or component. For example, while an external funding system and the gaming establishment fund management system are illustrated as separate components, the external funding system and the gaming establishment fund management system may be combined into a single component operable to accomplish the various tasks each of such separate components are described as accomplishing individually.

In certain embodiments, the system enables a transfer of funds between different accounts maintained by one or more gaming establishment components. In these embodiments, the system employs a service for interfacing with the various components to facilitate balance inquiries and the transfer of funds. In certain embodiments, such a service collects data from various components and utilizes such collected data to provide a singular view of the balances (or a plurality of singular views of different groupings of balances) available. In certain embodiments, such a service additionally or alternatively provides facilities to enforce rules and/or limitations including, but are not limited to, jurisdictional controls, self-imposed limits, state governmental controls and federal governmental controls, wherein the system provides the logic to determine how, and how much, to transfer to satisfy a request for funds while staying within the confines of such rules. In certain embodiments, such a service additionally or alternatively tracks and coalesces transaction history of the interconnected components of the system such that all transactions within the system have a “master” transaction record that ties all of the various fund transfers to a single initiating funds transfer.

In various embodiments, while certain users may open a gaming establishment retail account prior to undertaking any gaming establishment retail transactions, other users may not open such accounts (and rather the system will automatically open such a gaming establishment retail account if warranted and when needed to facilitate a gaming establishment retail transaction). In these embodiments, for users whom want to open a gaming establishment account with a gaming establishment retail wallet system prior to an attempted gaming establishment retail transaction, the system enables the user to utilize an interface, such as a mobile device application being executed by a mobile device, a website accessed from a browser and/or a service window displayed by EGM (or other gaming device), to attempt to open a gaming establishment retail account through one or more interactive forms. For example, as part of opening a gaming establishment retail account, a user (whom has already logged into one or more gaming establishment fund management system accounts via a mobile device application) makes one or more inputs via an interface to provide certain user identifying information and/or certain anticipated spending information, such as how the user intends to spend the funds withdrawn from such an account if opened.

In one such embodiment, in association with the opening of the account, the user is provided a retail wallet identity taking the form of a physical instrument associated with the gaming establishment retail account and/or a gaming establishment patron management system account. In another such embodiment, the user is provided a code to activate their gaming establishment retail account and/or download a mobile identification (e.g., a mobile pass representing a retail wallet identity) via logging into a mobile device application associated with the gaming establishment or logging into a website associated with the gaming establishment. In another such embodiment, the user is sent a short message service (“SMS”) text and/or e-mail informing the user how to activate their gaming establishment retail account and/or download a mobile identification via logging into a mobile device application associated with the gaming establishment or logging into a website associated with the gaming establishment. In certain embodiments, the system enables a user, such as a retail patron, to enroll or otherwise sign up for such accounts via other avenues, such as via picking up a retail account card at various locations, such as shops, throughout the gaming establishment, via a mobile application running on a mobile device, via a point-of-sale terminal, via an EGM, via a kiosk and/or via adding a retail account to an existing gaming establishment patron management system account, such as a player tracking account. In these embodiments, to facilitate a transfer of funds to an account associated with a retailer to purchase goods and/or services from the retailer, the user will present a retail wallet identity (e.g., a physical card associated with the gaming establishment retail account, a mobile device running a mobile device application associated with the gaming establishment retail account, or a mobile device that presents an identity associated with the user or the user's gaming establishment retail account) to potentially access funds from the gaming establishment retail account for the purchase transaction.

In certain embodiments, as part of a user opening a gaming establishment retail account, in association with the system automatically opening a gaming establishment retail account or in association with a previously opened gaming establishment retail account, the gaming establishment fund management system determines zero, one or more security measures to invoke in association with each transaction that uses funds from a user's gaming establishment retail account. In these embodiments, to prevent unauthorized access to the funds associated with the user's gaming establishment retail account, the system applies such determined security measures in association with any transaction that attempts to use funds from the user's gaming establishment retail account (and/or funds from zero, one or more other accounts maintained in association with the user). For example, if a user is required to enter a personal identification number (“PIN”) for each attempted transfer of funds from a gaming establishment retail account to complete a retail transaction regardless of any determination that the nature of the transaction warrants any additional degree of protection to combat any attempted fraud associated with the transaction, such a PIN would not qualify as an enhanced security measure. In another example, if a user is not required to enter a PIN for each attempted transfer of funds from a gaming establishment retail account to complete a retail transaction but following a determination that the nature of the transaction warrants requiring the user to enter a PIN as an additional degree of protection to combat any attempted fraud associated with the retail transaction, such a PIN would qualify as an enhanced security measure.

In certain embodiments, as part of a user opening a gaming establishment retail account, in association with the system automatically opening a gaming establishment retail account or in association with a previously opened gaming establishment retail account, the gaming establishment fund management system determines one or more controls or restrictions to associate with the gaming establishment retail account wherein if such conditions are satisfied, the gaming establishment fund management system denies the transaction or invokes one or more security measures. In these embodiments, to balance the need to prevent unauthorized access to the funds associated with the user's gaming establishment retail account against the need to provide a frictionless experience for users, the gaming establishment fund management system dynamically employs one or more controls such that certain transactions trigger the need to potentially employ enhanced security measures and certain transactions do not trigger the need to potentially employ enhanced security measures.

In certain embodiments, since certain users do not have a gaming establishment retail account prior to an attempted gaming establishment retail transaction, the system enables such users to still participate in the purchase of goods and/or services from a gaming establishment retailer via the on-demand creation of a gaming establishment retail account. In these embodiments, the user presents a user identity (e.g., a physical card associated with a gaming establishment patron management system account, a mobile device running a mobile device application associated with a gaming establishment patron management system account, or a mobile device that presents an identity associated with the user) to potentially cause the creation of a gaming establishment retail account and the subsequent access of funds from the created gaming establishment retail account for the purchase transaction.

In operation of certain embodiments, in association with an initial gaming establishment retail transaction and following an identification of a user from a presented user identity at an applicable point-of-sale terminal of a retail point-of-sale system within or otherwise associated with the gaming establishment for the purchase of goods and/or services, the system determines if a gaming establishment retail account exists for the identified user. For example, when a user interacts with a point-of-sale terminal by swiping their patron management system card (e.g., a player tracking card), the point-of-sale terminal communicates data associated with the attempted retail transaction and a patron management system card identification and/or a user identification to a component of the gaming establishment retail wallet system. In this example, responsive to receipt of this data, the gaming establishment retail wallet system reviews one or more databases to determine if a gaming establishment retail account exists in association with the patron management system card identification and/or the user identification.

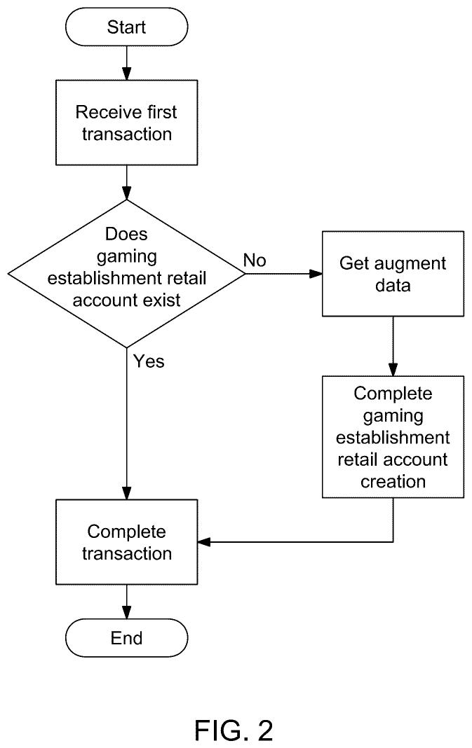

If the gaming establishment retail wallet system determines that no gaming establishment retail account exists for the identified user, as seen in FIG. 2, the gaming establishment retail wallet system (and/or another component of the gaming establishment fund management system) creates a gaming establishment retail account for the requested retail transaction. In such embodiments, the lack of a gaming establishment retail account does not prevent the user from partaking in certain gaming establishment retail transactions as the system automatically creates (or automatically partially creates) a gaming establishment retail account for the user. That is, in certain instances, a gaming establishment retail account creation event occurs, on demand, based on an attempted gaming establishment retail transaction such that the system operates to automatically initiate the creation of a gaming establishment retail account (subject to zero, one or more additional steps required of the user, such as the user separately acknowledging that they are signing up for a gaming establishment retail account and accepting the terms and conditions required for such an account).

Following the creation (or partial creation) of the gaming establishment account or if the gaming establishment retail wallet system (and/or another component of the gaming establishment fund management system) determines that a gaming establishment retail account already existed for the identified user, the gaming establishment retail wallet system (and/or another component of the gaming establishment fund management system) determines whether or not to complete the attempted retail purchase. In such embodiments, upon receiving data or information regarding the created (or existing) gaming establishment retail account, the gaming establishment retail wallet system determines if the gaming establishment retail account has adequate funds for the intended purchase.

If the gaming establishment retail wallet system indicates that the gaming establishment retail account lacks adequate funds for the purchase, the gaming establishment retail wallet system operates with another component of the gaming establishment fund management system (e.g., a gaming establishment cashless wagering system) that maintains another gaming establishment account (e.g., a cashless wagering account) to determine if the other gaming establishment account has adequate funds for the intended purchase. If the other gaming establishment account includes (when combined with any funds maintained in the gaming establishment retail account) adequate funds for the intended purchase, the system causes a transfer of funds from the other gaming establishment account to the gaming establishment retail account for the intended purchase. Such a transfer from the other gaming establishment account to the gaming establishment retail account includes an increase of a balance of the gaming establishment retail account and a corresponding decrease of a balance of the other gaming establishment account. In certain embodiments, such a transfer between different gaming establishment accounts is associated with the display of one or more messages to the user.

If the gaming establishment retail wallet system indicates that the gaming establishment retail account includes adequate funds for the purchase or following the transfer of funds from the other gaming establishment account to the gaming establishment retail account for the intended purchase, the gaming establishment retail wallet system authorizes the sale of the goods and/or services. The gaming establishment retail wallet system then proceeds to transfer an amount of funds to cover the purchased goods and/or services from the gaming establishment retail account to an account associated with the retail point-of-sale system (and/or the retail establishment) to complete the purchase of the goods and/or services. Such a transfer of funds to complete the purchase of the goods and/or services is associated with a transaction identification which one or more components of the system store for reporting purposes. In certain embodiments, such a transfer to complete the purchase is associated with the display of one or more messages to the user and/or the providing of a receipt for the completed purchase transaction.

On the other hand, if the gaming establishment retail wallet system indicates that the gaming establishment retail account lacks adequate funds for the purchase and if no other gaming establishment account includes adequate funds (when combined with any funds maintained in the gaming establishment retail account) for the intended purchase, the system denies this sale transaction of the goods and/or services using the gaming establishment retail account. In certain embodiments, such a denial of the purchase transaction is associated with the display of one or more messages to the user.

It should be appreciated that in certain embodiments, when initially created, the gaming establishment retail account is associated with minimal data regarding the user (i.e., the created gaming establishment retail account is a partial gaming establishment retail account since certain data is lacking). In such embodiments, to complete the creation of a gaming establishment retail account, as seen in FIG. 2, the gaming establishment retail wallet system (and/or another component of the gaming establishment fund management system) supplements this minimal data regarding the user with additional or augment data from one or more components that maintain one or more non-gaming establishment retail accounts. In certain embodiments, the gaming establishment retail wallet system (and/or another component of the gaming establishment fund management system) utilizes part or all of the information employed to establish another gaming establishment account to create a separate and distinct gaming establishment retail account. In these embodiments, the gaming establishment retail wallet system coordinates with components of other gaming establishment systems that maintain such other gaming establishment accounts to obtain certain information employed to create a gaming establishment retail account for the user.

In certain embodiments, the source of supplemental data to augment the data initially associated with the created gaming establishment retail account include another component of the gaming establishment fund management system that maintains another gaming establishment fund management system account. For example, the source of supplemental data to augment the data initially associated with the created gaming establishment retail account include data previously provided by the user in association with the user opening or otherwise enrolling in a cashless wagering account maintained by a cashless wagering system. In this example, since the cashless wagering system employed, in opening a cashless wagering account for a user, certain user identifying information (such as, but not limited to, a name, an address, a date of birth, a portion of a government issued social security number (e.g., the last four digits), a copy of a signature and/or a mother's maiden name) and since, in certain instances, the cashless wagering system additionally utilized part or all of such identifying information to operate with a financial institution (or other third-party) to perform one or more Know Your Customer (“KYC”) checks to further validate the information, the gaming establishment retail wallet system harnesses some or all of this data to assist in opening and/or augmenting a gaming establishment retail account.

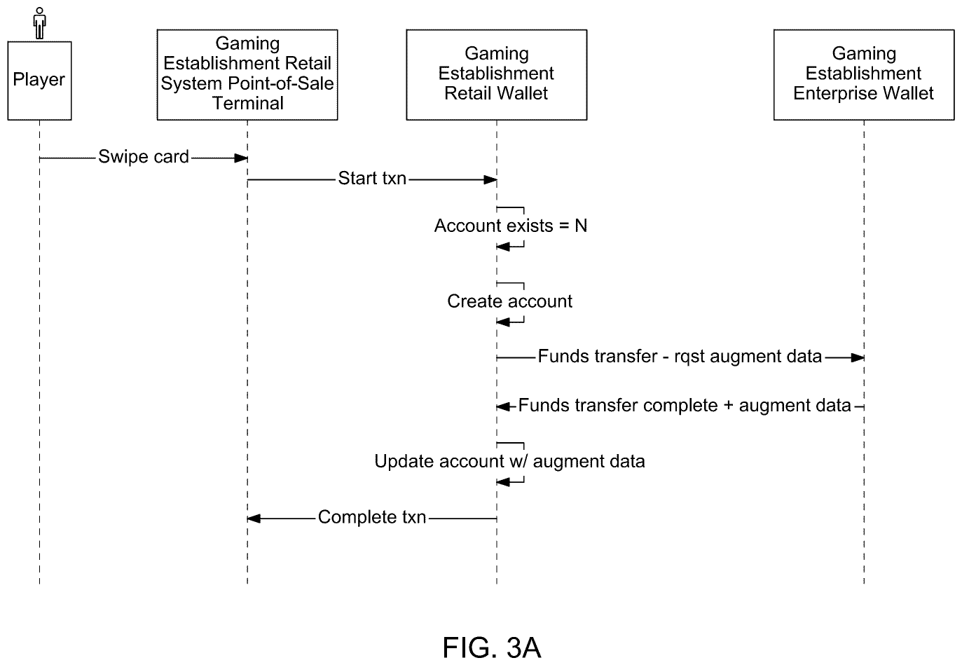

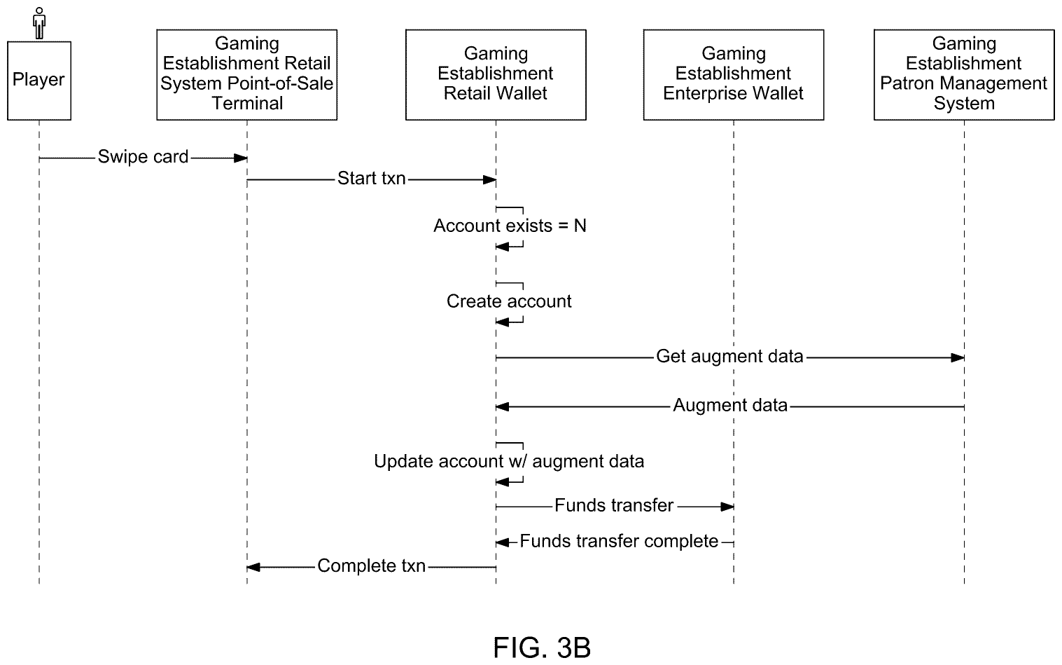

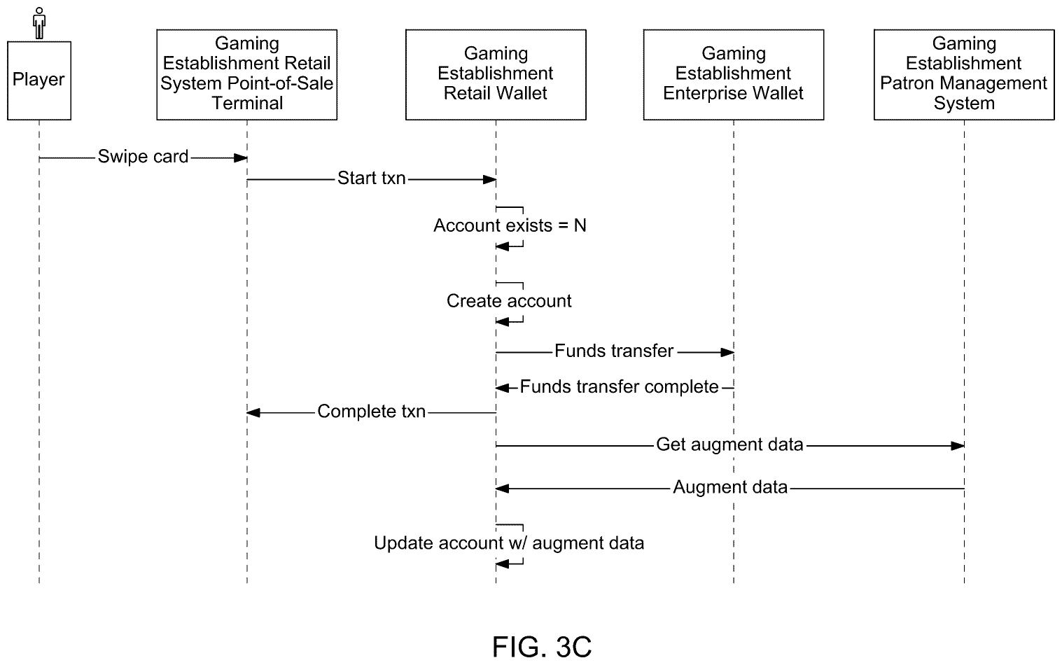

In certain embodiments, the augmentation of data associated with the created gaming establishment retail account occurs in association with the attempted gaming establishment retail transaction that necessitated the creation of the gaming establishment retail account. In these embodiments, prior to the completion of the gaming establishment retail transaction, the gaming establishment retail wallet system operates with one or more components that maintain one or more other gaming establishment fund management system accounts to obtain certain data used to establish one or more attributes of the created gaming establishment retail account. For example and as seen in FIG. 3A (which illustrates certain interactions involving a user, such as a player, a point-of-sale terminal of a gaming establishment retail system, a gaming establishment retail wallet system and a component of the gaming establishment fund management system), certain embodiments enable the creation of a gaming establishment retail account in association with an attempted gaming establishment retail transaction. As seen in FIG. 3A, in this example, to complete the gaming establishment retail transaction, the gaming establishment retail account is funded via a transfer of funds from another gaming establishment fund management system account. As also seen in FIG. 3A, prior to the completion of the gaming establishment retail transaction, certain data associated with the other gaming establishment fund management system account is employed to establish one or more attributes of the created gaming establishment retail account.

In certain embodiments, the source of supplemental data to augment the data initially associated with the created gaming establishment retail account include a component of the gaming establishment patron management system that maintains a gaming establishment patron management system account. For example, the source of supplemental data to augment the data initially associated with the created gaming establishment retail account include data previously provided by the user in association with the user opening or otherwise enrolling in a player tracking account maintained by a player tracking system. In this example, since the player tracking system employed, in opening a player tracking account for a user, certain user identifying information (such as, but not limited to, a name, an address, a date of birth), the gaming establishment retail wallet system harnesses some or all of this data to assist in opening and/or augmenting a gaming establishment retail account.

In certain embodiments, the gaming establishment retail wallet system operates with one or more components of the gaming establishment patron management system to obtain certain data used to modify one or more attributes of the created gaming establishment retail account. For example and as seen in FIG. 3B (which illustrates certain interactions involving a user, such as a player, a point-of-sale terminal of a gaming establishment retail system, a gaming establishment retail wallet system, a component of the gaming establishment fund management system and a component of a gaming establishment patron management system), certain embodiments enable the creation of a gaming establishment retail account in association with an attempted gaming establishment retail transaction. As seen in FIG. 3B, in this example, to complete the gaming establishment retail transaction, the gaming establishment retail account is funded via a transfer of funds from another gaming establishment fund management system account. As also seen in FIG. 3B, prior to the completion of the gaming establishment retail transaction, certain data associated with the gaming establishment patron management system account is employed to update the created gaming establishment retail account.

In certain embodiments in which the source of supplemental data to augment the data initially associated with the created gaming establishment retail account include another component of the gaming establishment fund management system that maintains another gaming establishment fund management system account and/or a component of the gaming establishment patron management system that maintains a gaming establishment patron management system account, the augmentation of data associated with the created gaming establishment retail account occurs after a completion of the gaming establishment retail transaction that necessitated the creation of the gaming establishment retail account. In these embodiments, following the completion of the gaming establishment retail transaction, the gaming establishment retail wallet system operates with one or more other components that maintain one or more other accounts to obtain certain data used to modify one or more attributes of the created gaming establishment retail account. For example and as seen in FIG. 3C (which illustrates certain interactions involving a user, such as a player, a point-of-sale terminal of a gaming establishment retail system, a gaming establishment retail wallet system, a component of the gaming establishment fund management system and a component of a gaming establishment patron management system), certain embodiments enable the creation of a gaming establishment retail account in association with an attempted gaming establishment retail transaction. As seen in FIG. 3C, in this example, to complete the gaming establishment retail transaction, the gaming establishment retail account is funded via a transfer of funds from another gaming establishment fund management system account. As also seen in FIG. 3C, after the completion of the gaming establishment retail transaction, certain data associated with the gaming establishment patron management system account is employed to update the created gaming establishment retail account.

It should be appreciated that in addition to creating a gaming establishment retail account in association with a first attempted gaming establishment retail transaction that would utilize such a gaming establishment retail account, in certain embodiments, responsive to a user signing up for another gaming establishment account separate from an attempted gaming establishment retail transaction, the gaming establishment retail account creation event occurs. For example, a gaming establishment retail account creation event occurs when a user signs up for another gaming establishment account (e.g., a cashless wagering account and/or a player tracking account) independent of any attempted gaming establishment retail transaction. In this example, when the user provides various information to sign up for the other gaming establishment account, the system recognizes that the user also does not have a gaming establishment retail account such that the system automatically creates the gaming establishment retail account for the user employing certain information collected from the user with the user's registration for the other gaming establishment account.

In certain other embodiments, responsive to an occurrence of a triggering event that occurs separate from an attempted gaming establishment retail transaction, the system utilizes part or all of the information employed from the establishment of another gaming establishment account to create a gaming establishment retail account. For example, a gaming establishment retail account creation event occurs when, independent of an attempted gaming establishment retail transaction, a user whom previously signed up for another gaming establishment account (e.g., a cashless wagering account and/or a player tracking account) starts a wagering session at an EGM (or transfers funds to the other gaming establishment account). In this example, when the user starts a wagering session at an EGM (or transfers funds to the other gaming establishment account), the system recognizes that the user has another gaming establishment account but not a gaming establishment retail account such that the system automatically creates the gaming establishment retail account for the user employing certain information previously collected from the user when the user registered for the other gaming establishment account.

In certain embodiments, as mentioned above, to facilitate a gaming establishment retail transaction with funds transferred from a created gaming establishment retail account to an account associated with a retail establishment, an amount of funds are transferred to the gaming establishment retail account. In certain embodiments in which the user is associated with another gaming establishment account operable to hold funds, such as a cashless wagering account, subject to that other gaming establishment account having at least a requested amount of funds to complete a gaming establishment retail transaction, the system transfers funds to the created gaming establishment retail account from that other gaming establishment account. In certain embodiments in which the user is not associated with another gaming establishment account operable to hold funds or the user is associated with another gaming establishment account operable to hold funds but that other gaming establishment account does not have at least a requested amount of funds to complete a gaming establishment retail transaction, the system transfers funds to the created gaming establishment retail account from an external account (either directly or indirectly via the other gaming establishment account operable to hold funds).

In certain embodiments, the amount of funds transferred to the created gaming establishment retail account match the amount of funds needed to complete the gaming establishment retail transaction such that the created gaming establishment retail account generally avoids holding any amounts of funds for any relatively extended durations of time. In these embodiments, if multiple gaming establishment retail transactions are not anticipated (e.g., the user is not currently staying at a hotel associated with the gaming establishment), the system transfers an exact amount of funds to the created gaming establishment retail account to complete the gaming establishment retail transaction. Such embodiments increase the efficiency of the system by reducing the amount of accounts associated with a gaming establishment that actively hold funds (which are associated with various reporting requirements and one or more corresponding backing accounts) as well as reducing instances of having to dedicate operational resources to returning any unused funds from the created gaming establishment retail to other gaming establishment accounts (and/or one or more external accounts maintained independent of the system).

In certain embodiments, in anticipation of one or more subsequent gaming establishment retail transactions associated with the created gaming establishment retail account, the amount of funds transferred to the created gaming establishment retail account exceed the amount of funds needed to complete the gaming establishment retail transaction. In certain such embodiments, subject to another gaming establishment account having an adequate amount of funds, the system rounds up the amount of funds transferred to the gaming establishment retail account, such as by rounding up a requested transfer amount by $10 or by $100. In these embodiments, since the funds transferred to an account of a gaming establishment retailer to complete a purchase transaction may first have to be transferred from another gaming establishment account operable to hold funds, such as a cashless wagering account, to the created gaming establishment retail account and then from the gaming establishment retail account to the account of the gaming establishment retailer, transacting against the other gaming establishment account for each purchase made by a user during a user's visit to a gaming establishment would potentially exponentially increase the computational load placed on the system. Accordingly, in anticipation of the relatively high quantity of gaming establishment retail transactions occurring during a relatively short period of time (e.g., during a user's planned trip to a gaming establishment) and to avoid stressing the system by transacting against the same non-gaming establishment retail account multiple times over a relatively short period of time, the system of certain embodiments reduces the operational load introduced by such frequent retail transactions by employing the created gaming establishment retail account to hold an amount of funds (for the relatively short period of time) that exceed the immediate need for such an amount of funds.

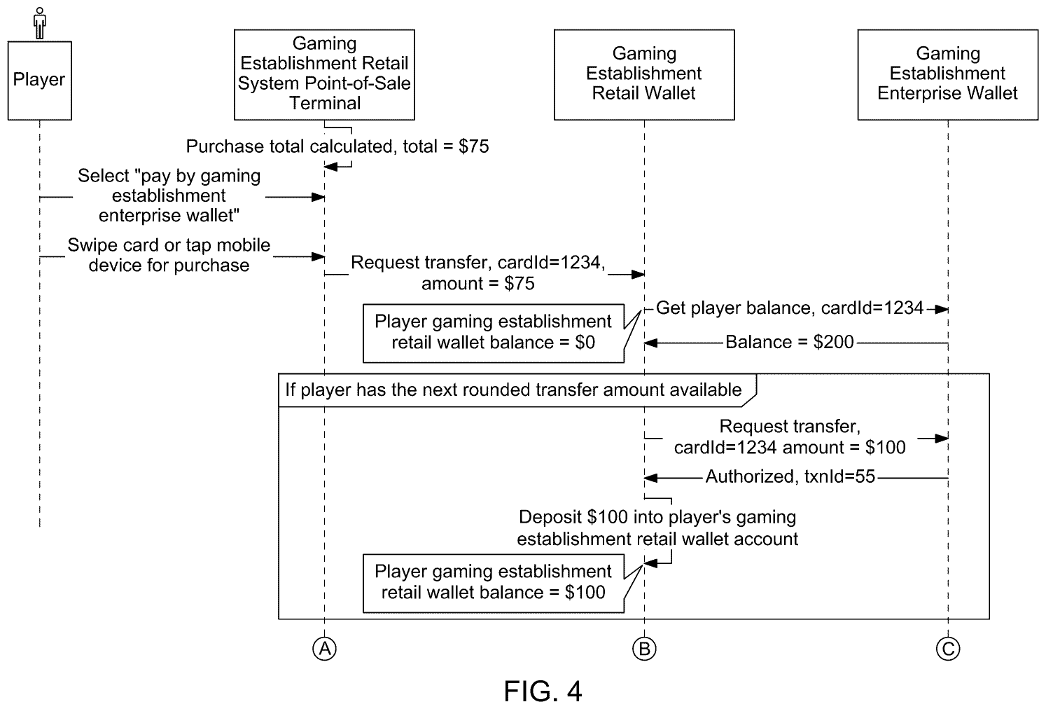

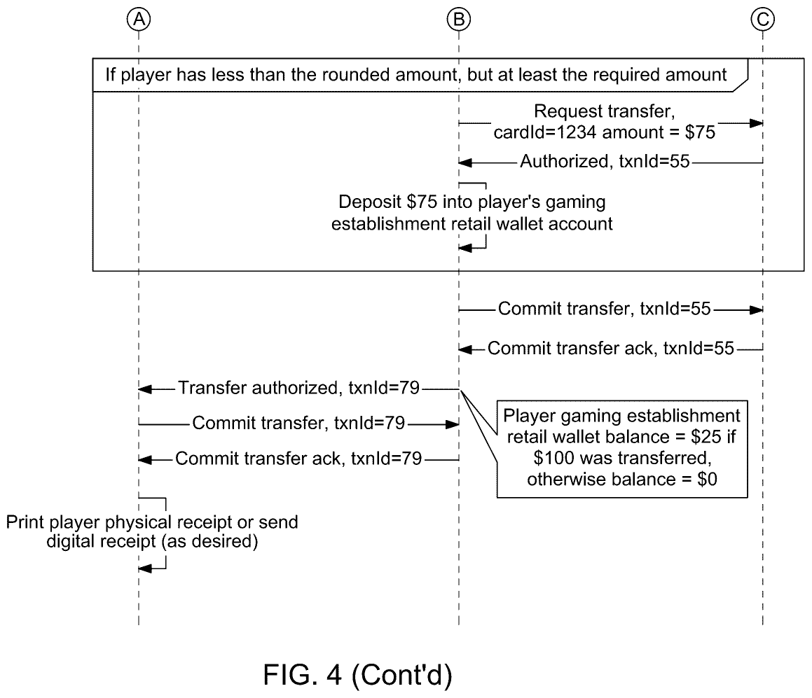

In certain such embodiments, following the creation of a gaming establishment retail account based on a first requested retail transaction, the system utilizes the gaming establishment retail account to accumulate, if possible, additional funds from one or more other gaming establishment accounts and escrow such additional funds prior to use. In these embodiments, given the excessive infrastructure load introduced by relatively high frequency transactions against such other gaming establishment accounts (and the corresponding limits to scalability of the system due to such excessive infrastructure loads), the system alleviates such excessive infrastructure loads on the overall system by anticipating future retail transactions and transfers an amount of funds to the created gaming establishment retail account in anticipation of the need of such funds. In other words, to mitigate the load placed upon the other gaming establishment accounts associated with the system, the system automatically bulk-loads funds into the gaming establishment retail account for a period of time. For example and as seen in FIG. 4 (which illustrates certain interactions involving a user, such as a player, a point-of-sale terminal of a gaming establishment retail system, a gaming establishment retail wallet system and a component of the gaming establishment fund management system), certain embodiments enable, in association with an attempted gaming establishment retail transaction and subject to availability, an excess amount of funds to be transferred to a gaming establishment retail account for anticipated use from the gaming establishment retail account.

It should be appreciated that this bulk-loading of the gaming establishment retail account with funds anticipated to be used and then transacting against the gaming establishment retail account on a per transaction basis provides that the system does not need to repeatedly transact against other gaming establishment accounts maintained by the system (and/or one or more external accounts maintained independent of the system) for each gaming establishment retail transaction. Such a configuration of automatically transferring funds from various gaming establishment accounts to a gaming establishment retail account in anticipation of certain retail activity additionally reduces the number of account balance queries associated with the system since part or all of an amount of funds projected to be used for the anticipated retail activity will reside, by design, in the gaming establishment retail account. As such, employing the gaming establishment retail account to periodically hold certain amounts of funds increases the efficiency of the system by reducing the amount of fund transfers needed in association with the gaming establishment retail account to complete multiple gaming establishment retail transactions.

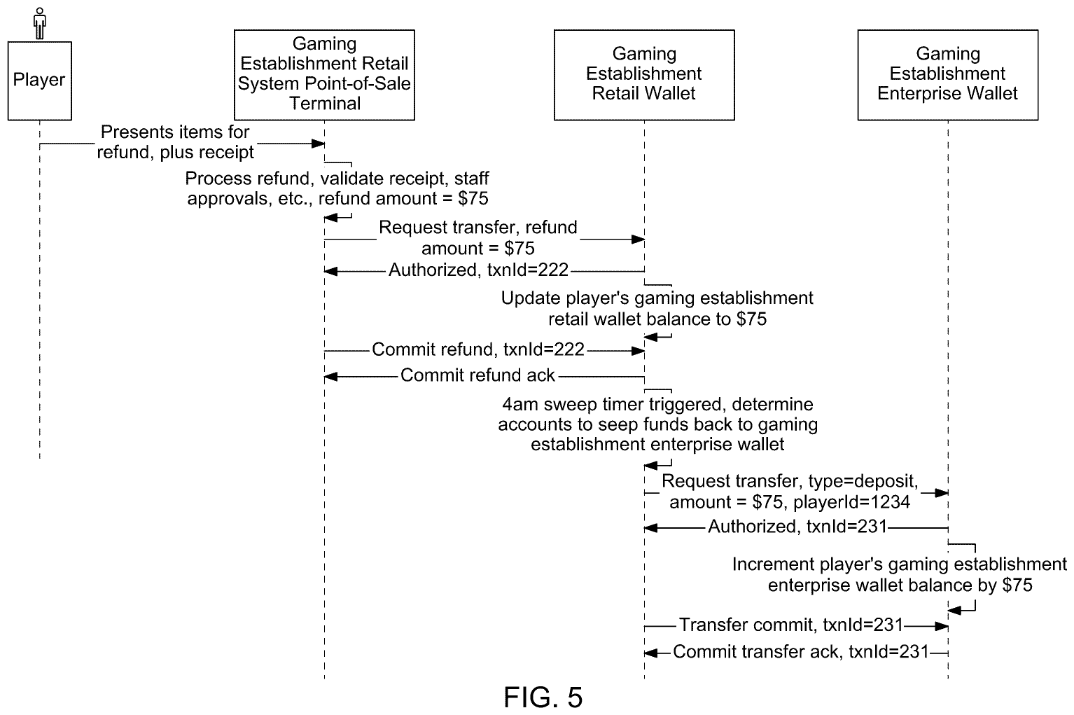

In certain embodiments in which the attempted retail transaction is an attempted refund transaction (e.g., an attempted return of goods and/or services at a point-of-sale terminal of a gaming establishment retail point-of-sale system purchased with funds from the created gaming establishment retail account), a component of the gaming establishment retail wallet system (and/or another component of the gaming establishment fund management system) operates with a component of the gaming establishment retail point-of-sale system to determine whether or not to authorize the refund transaction. In these embodiments, upon an approval of the refund transaction, the component of the gaming establishment retail wallet system (and/or another component of the gaming establishment fund management system) operates with the component of the retail point-of-sale system to modify the balance of the gaming establishment retail account to reflect the amount of funds associated with the refund transaction. In such embodiments, in association with such a transfer (or scheduled transfer) of funds to the gaming establishment retail account, the gaming establishment retail wallet system (and/or another component of the gaming establishment fund management system) communicates a notification to the point-of-sale terminal to complete the attempted refund transaction. For example and as seen in FIG. 5 (which illustrates certain interactions involving a user, such as a player, a point-of-sale terminal of a gaming establishment retail system, a gaming establishment retail wallet system and a component of the gaming establishment fund management system), certain embodiments enable, in association with a gaming establishment retail return transaction, an amount of funds to be transferred to a gaming establishment retail account.

In certain embodiments, in addition to transferring funds to the created gaming establishment retail account responsive to a refund transaction (and/or responsive to one or more fund bulk-loading events), the system periodically transfers funds away from the created gaming establishment retail account. For example, if a gaming establishment retail transaction does not occur in association with the created gaming establishment retail account over a period of time, such as over twenty-four hours, the system determine that a series of one or more anticipated retail transactions are not immediately expected to be requested against the funds in the gaming establishment retail account (i.e., the account is not expected to be actively used within a designated time period) and the system transfers the funds in the gaming establishment retail account to one or more other gaming establishment accounts (and/or one or more external accounts maintained independent of the system). In certain embodiments, in addition to transferring funds to the created gaming establishment retail account responsive to a refund transaction (and/or responsive to one or more fund bulk-loading events), the system transfers funds away from the created gaming establishment retail account responsive to one or more events, such as a need for such funds by one or more other components of the gaming establishment fund management system. In these embodiments, upon the determination to sweep funds from the gaming establishment retail account, the system transfers the funds in the gaming establishment retail account to one or more other gaming establishment accounts (and/or one or more external accounts maintained independent of the system). Continuing with the example of FIG. 5, following the gaming establishment retail return transaction which resulted in an amount of funds being transferred to the gaming establishment retail account, at a certain time of day (e.g., every morning at 4:00 AM), the system operates to transfer funds held in the gaming establishment retail account to another gaming establishment account maintained in association with another component of the gaming establishment fund management system. As illustrated in this example, upon a refunding event associated with a gaming establishment retail account, the system causes part or all of the amount of funds in the gaming establishment retail account to be transferred away from that account and to another gaming establishment account.

It should be appreciated that any functionality or process of the present disclosure may be implemented via one or more servers (associated with or independent of any component of the gaming establishment fund management system), a mobile device application, one or more gaming establishment devices (e.g., a gaming device such as an EGM or a non-gaming device such as a point-of-sale terminal of a retailer located within or otherwise associated with a gaming establishment), and/or one or more components of a gaming establishment system (such as a component of a gaming establishment patron management system supported by or otherwise located inside a gaming establishment device and/or a non-gaming establishment device). Accordingly: (i) while certain functions, features or processes are described herein as being performed by one (or more) device (e.g., a server, a mobile device application, a gaming establishment device, a component of a gaming establishment system), such functions, features or processes may alternatively be performed, if applicable, by another such different devices.

In certain embodiments, the above-described embodiments of the present disclosure may be implemented in accordance with or in conjunction with zero, one or more components of one or more systems (e.g., a gaming establishment retail wallet system, a gaming establishment patron management system, a gaming establishment fund management system, and/or an external funding system) and/or zero, one or more gaming establishment devices. In these embodiments, such a component of the system and/or the gaming establishment device each include a controller including at least one processor.

The at least one processor is any suitable processing device or set of processing devices, such as a microprocessor, a microcontroller-based platform, a suitable integrated circuit, or one or more application-specific integrated circuits (ASICs), configured to execute software enabling various configuration and reconfiguration tasks, such as: (1) communicating with a remote source (such as a server that stores authentication information or fund information) via a communication interface of the controller; (2) converting signals read by an interface to a format corresponding to that used by software or memory of the component of the system and/or the gaming establishment device; (3) accessing memory to configure or reconfigure parameters in the memory according to indicia read from the component of the system and/or the gaming establishment device; (4) communicating with interfaces and the peripheral devices (such as input/output devices); and/or (5) controlling the peripheral devices. In certain embodiments, one or more components of the controller (such as the at least one processor) reside within a housing of the component of the system and/or the gaming establishment device, while in other embodiments, at least one component of the controller resides outside of the housing of the component of the system and/or the gaming establishment device.

The controller also includes at least one memory device, which includes: (1) volatile memory (e.g., RAM which can include non-volatile RAM, magnetic RAM, ferroelectric RAM, and any other suitable forms); (2) non-volatile memory (e.g., disk memory, FLASH memory, EPROMS, EEPROMs, memristor-based non-volatile solid-state memory, etc.); (3) unalterable memory (e.g., EPROMs); (4) read-only memory; and/or (5) a secondary memory storage device, such as a non-volatile memory device, configured to store software related information (the software related information and the memory may be used to store various files not currently being used and invoked in a configuration or reconfiguration). Any other suitable magnetic, optical, and/or semiconductor memory may operate in conjunction with the component of the system and/or the gaming establishment device disclosed herein. In certain embodiments, the at least one memory device resides within the housing of the component of the system and/or the gaming establishment device, while in other embodiments at least one component of the at least one memory device resides outside of the housing of the component of the system and/or the gaming establishment device. In these embodiments, any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

The at least one memory device is configured to store, for example: (1) configuration software, such as all the parameters and settings on the component of the system and/or the gaming establishment device; (2) associations between configuration indicia read from the component of the system and/or the gaming establishment device with one or more parameters and settings; (3) communication protocols configured to enable the at least one processor to communicate with the peripheral devices; and/or (4) communication transport protocols (such as TCP/IP, USB, Firewire, IEEE1394, Bluetooth, IEEE 802.11x (IEEE 802.11 standards), hiperlan/2, HomeRF, etc.) configured to enable the component of the system and/or the gaming establishment device to communicate with local and non-local devices using such protocols. In one implementation, the controller communicates with other devices using a serial communication protocol. A few non-limiting examples of serial communication protocols that other devices, such as peripherals (e.g., a bill validator or a ticket printer), may use to communicate with the controller include USB, RS-232, and Netplex (a proprietary protocol developed by IGT).

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

In certain embodiments, the at least one memory device is configured to store program code and instructions executable by the at least one processor of the component of the system and/or the gaming establishment device to control the component of the system and/or the gaming establishment device. In various embodiments, part or all of the program code and/or the operating data described above is stored in at least one detachable or removable memory device including, but not limited to, a cartridge, a disk, a CD ROM, a DVD, a USB memory device, or any other suitable non-transitory computer readable medium. In certain such embodiments, an operator (such as a gaming establishment operator) uses such a removable memory device in a component of the gaming establishment fund management system to implement at least part of the present disclosure. In other embodiments, part or all of the program code and/or the operating data is downloaded to the at least one memory device of the component of the system and/or the gaming establishment device through any suitable data network described above (such as an Internet or intranet).

The at least one memory device also stores a plurality of device drivers. Examples of different types of device drivers include device drivers for the component of the system and/or the gaming establishment device and device drivers for the peripheral components. Typically, the device drivers utilize various communication protocols that enable communication with a particular physical device. The device driver abstracts the hardware implementation of that device. For example, a device driver may be written for each type of card reader that could potentially be connected to the component of the system and/or the gaming establishment device. Non-limiting examples of communication protocols used to implement the device drivers include Netplex, USB, Serial, Ethernet, Firewire, I/O debouncer, direct memory map, serial, PCI, parallel, RF, Bluetooth™, near-field communications (e.g., using near-field magnetics), 802.11 (WiFi), etc. In one embodiment, when one type of a particular device is exchanged for another type of the particular device, the at least one processor of the component of the system and/or the gaming establishment device loads the new device driver from the at least one memory device to enable communication with the new device. For instance, one type of card reader in the component of the system and/or the gaming establishment device can be replaced with a second different type of card reader when device drivers for both card readers are stored in the at least one memory device.

In certain embodiments, the software units stored in the at least one memory device can be upgraded as needed. For instance, when the at least one memory device is a hard drive, new parameters, new settings for existing parameters, new settings for new parameters, new device drivers, and new communication protocols can be uploaded to the at least one memory device from the controller or from some other external device. As another example, when the at least one memory device includes a CD/DVD drive including a CD/DVD configured to store options, parameters, and settings, the software stored in the at least one memory device can be upgraded by replacing a first CD/DVD with a second CD/DVD. In yet another example, when the at least one memory device uses flash memory or EPROM units configured to store options, parameters, and settings, the software stored in the flash and/or EPROM memory units can be upgraded by replacing one or more memory units with new memory units that include the upgraded software. In another embodiment, one or more of the memory devices, such as the hard drive, may be employed in a software download process from a remote software server.

In some embodiments, the at least one memory device also stores authentication and/or validation components configured to authenticate/validate specified components of the system, and/or the gaming establishment device and/or information, such as hardware components, software components, firmware components, peripheral device components, user input device components, information received from one or more user input devices, information stored in the at least one memory device, etc.

In certain embodiments, the peripheral devices include several device interfaces, such as, but not limited to: (1) at least one output device including at least one display device; (2) at least one input device (which may include contact and/or non-contact interfaces); (3) at least one transponder; (4) at least one wireless communication component; (5) at least one wired/wireless power distribution component; (6) at least one sensor; (7) at least one data preservation component; (8) at least one motion/gesture analysis and interpretation component; (9) at least one motion detection component; (10) at least one portable power source; (11) at least one geolocation module; (12) at least one user identification module; (13) at least one user/device tracking module; and (14) at least one information filtering module.

The at least one output device includes at least one display device configured to display any suitable information. In certain embodiments, the display devices are connected to or mounted on a housing of the component of the system and/or the gaming establishment device. For example, the display devices serve as digital glass configured to display aspects of the gaming establishment device. In various embodiments, the gaming establishment device includes zero, one or more of the following display devices: (a) a central display device; (b) a player tracking display configured to display various information regarding a user's player tracking status; (c) a secondary or upper display device in addition to the central display device and the player tracking display; (d) a credit display configured to display a current quantity of credits, amount of cash, account balance, or the equivalent; and (e) a bet display. In various embodiments, the display devices include, without limitation: a monitor, a television display, a plasma display, a liquid crystal display (LCD), a display based on light emitting diodes (LEDs), a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, as described above, the display device includes a touch-screen with an associated touch-screen controller. The display devices may be of any suitable sizes, shapes, and configurations.

In various embodiments, the at least one output device includes a payout device. For example, after the gaming establishment device receives an actuation, the gaming establishment device causes the payout device to provide a payment to the user. In one embodiment, the payout device is one or more of: (a) a ticket printer and dispenser configured to print and dispense a ticket or credit slip associated with a monetary value, wherein the ticket or credit slip may be redeemed for its monetary value via a cashier, a kiosk, or other suitable redemption system; (b) a bill dispenser configured to dispense paper currency; (c) a coin dispenser configured to dispense coins or tokens (such as into a coin payout tray); and (d) any suitable combination thereof. In certain embodiments, rather than dispensing bills, coins, or a physical ticket having a monetary value to the user following receipt of an actuation of the cashout device, the payout device is configured to cause a payment to be provided to the user in the form of an electronic funds transfer, such as via a direct deposit into a bank account, a casino account, or a prepaid account of the user; via a transfer of funds onto an electronically recordable identification card or smart card of the user; or via sending a virtual ticket having a monetary value to an electronic device of the user.

In certain embodiments, the at least one output device is a sound generating device controlled by one or more sound cards. In one such embodiment, the sound generating device includes one or more speakers or other sound generating hardware and/or software configured to generate sounds, such as by playing music. For example, the gaming establishment device provides dynamic sounds coupled with attractive multimedia images displayed on one or more of the display devices to provide an audio-visual representation or to otherwise display full-motion video with sound to attract users to the gaming establishment device. In certain embodiments, the gaming establishment device displays a sequence of audio and/or visual attraction messages during idle periods to attract potential users to the gaming establishment device. The videos may be customized to provide any appropriate information.

The at least one input device may include any suitable device that enables an input signal to be produced and received by the at least one processor of the component of the system and/or the gaming establishment device. In one embodiment, the at least one input device includes a payment device configured to communicate with the at least one processor of the gaming establishment device to fund the gaming establishment device. In certain embodiments, the payment device includes zero, one or more of: (a) a bill acceptor into which paper money is inserted; (b) a ticket acceptor into which a ticket or a voucher is inserted; (c) a reader or a validator for credit cards, debit cards, or credit slips into which a credit card, debit card, or credit slip is inserted; (d) a player identification card reader into which a player identification card is inserted; or (e) any suitable combination thereof. In one embodiment, the at least one input device includes a payment device configured to enable the gaming establishment device to be funded via an electronic funds transfer, such as a transfer of funds from a bank account. In another embodiment, the gaming establishment device includes a payment device configured to communicate with a mobile device of a user, such as a mobile phone, a radio frequency identification tag, or any other suitable wired or wireless device, to retrieve relevant information associated with that user to fund the gaming establishment device. When the gaming establishment device is funded, the at least one processor determines the amount of funds entered and displays the corresponding amount.

In various embodiments, the at least one input device includes a plurality of buttons that are programmable by the component of the system and/or the gaming establishment device operator to, when actuated, cause the component of the system and/or the gaming establishment device to perform particular functions. For instance, such buttons may be hard keys, programmable soft keys, or icons icon displayed on a display device of the gaming establishment device that are actuatable via a touch screen of the gaming establishment device or via use of a suitable input device of the gaming establishment device. In certain embodiments, the at least one input device includes a touch-screen coupled to a touch-screen controller or other touch-sensitive display overlay to enable interaction with any images displayed on a display device (as described below). One such input device is a conventional touch-screen button panel. The touch-screen and the touch-screen controller are connected to a video controller. In these embodiments, signals are input to the gaming establishment device by touching the touch screen at the appropriate locations.

The at least one wireless communication component includes one or more communication interfaces having different architectures and utilizing a variety of protocols, such as (but not limited to) 802.11 (WiFi); 802.15 (including Bluetooth™M); 802.16 (WiMax); 802.22; cellular standards such as CDMA, CDMA2000, and WCDMA; Radio Frequency (e.g., RFID); infrared; and Near Field Magnetic communication protocols. The at least one wireless communication component transmits electrical, electromagnetic, or optical signals that carry digital data streams or analog signals representing various types of information.

The at least one wired/wireless power distribution component includes components or devices that are configured to provide power to other devices. For example, in one embodiment, the at least one power distribution component includes a magnetic induction system that is configured to provide wireless power to one or more user input devices near the component of the system and/or the gaming establishment device. In one embodiment, a user input device docking region is provided, and includes a power distribution component that is configured to recharge a user input device without requiring metal-to-metal contact. In one embodiment, the at least one power distribution component is configured to distribute power to one or more internal components of the component of the system and/or the gaming establishment device, such as one or more rechargeable power sources (e.g., rechargeable batteries) located at the component of the system and/or the gaming establishment device.

In certain embodiments, the at least one sensor includes at least one of: optical sensors, pressure sensors, RF sensors, infrared sensors, image sensors, thermal sensors, and biometric sensors. The at least one sensor may be used for a variety of functions, such as: detecting movements and/or gestures of various objects within a predetermined proximity to the component of the system and/or the gaming establishment device; detecting the presence and/or identity of various persons (e.g., users, casino employees, etc.), devices (e.g., user input devices), and/or systems within a predetermined proximity to the component of the system and/or the gaming establishment device.

The at least one data preservation component is configured to detect or sense one or more events and/or conditions that, for example, may result in damage to the component of the system and/or the gaming establishment device and/or that may result in loss of information associated with the component of the system and/or the gaming establishment device. Additionally, the data preservation system may be operable to initiate one or more appropriate action(s) in response to the detection of such events/conditions.

The at least one motion/gesture analysis and interpretation component is configured to analyze and/or interpret information relating to detected user movements and/or gestures to determine appropriate user input information relating to the detected user movements and/or gestures. For example, in one embodiment, the at least one motion/gesture analysis and interpretation component is configured to perform one or more of the following functions: analyze the detected gross motion or gestures of a user; interpret the user's motion or gestures (e.g., in the context of a casino game being played) to identify instructions or input from the user; utilize the interpreted instructions/input to advance the game state; etc. In other embodiments, at least a portion of these additional functions may be implemented at a remote system or device.

The at least one portable power source enables the component of the system and/or the gaming establishment device to operate in a mobile environment.

The at least one geolocation module is configured to acquire geolocation information from one or more remote sources and use the acquired geolocation information to determine information relating to a relative and/or absolute position of the component of the system and/or the gaming establishment device. For example, in one implementation, the at least one geolocation module is configured to receive GPS signal information for use in determining the position or location of the gaming establishment device. In another implementation, the at least one geolocation module is configured to receive multiple wireless signals from multiple remote devices and use the signal information to compute position/location information relating to the position or location of the gaming establishment device.

The at least one user identification module is configured to determine the identity of the current user or current owner of the component of the system and/or the gaming establishment device. For example, in one embodiment, the current user is required to perform a login process at the component of the system and/or the gaming establishment device in order to access one or more features. Alternatively, the component of the system and/or the gaming establishment device is configured to automatically determine the identity of the current user based on one or more external signals, such as an RFID tag or badge worn by the current user and that provides a wireless signal to the component of the system and/or the gaming establishment device that is used to determine the identity of the current user. In at least one embodiment, various security features are incorporated into the component of the system and/or the gaming establishment device to prevent unauthorized users from accessing confidential or sensitive information.

The at least one information filtering module is configured to perform filtering (e.g., based on specified criteria) of selected information to be displayed at one or more displays of the component of the system and/or the gaming establishment device.

In various embodiments, the component of the system and/or the gaming establishment device includes a plurality of communication ports configured to enable the at least one processor of the component of the system and/or the gaming establishment device to communicate with and to operate with external peripherals, such as: accelerometers, arcade sticks, bar code readers, bill validators, biometric input devices, bonus devices, button panels, card readers, coin dispensers, coin hoppers, display screens or other displays or video sources, expansion buses, information panels, keypads, lights, mass storage devices, microphones, motion sensors, motors, printers, reels, SCSI ports, solenoids, speakers, thumbsticks, ticket readers, touch screens, trackballs, touchpads, wheels, and wireless communication devices.

As generally described above, in certain embodiments, the component of the system and/or the gaming establishment device has a support structure, housing, or cabinet that provides support for a plurality of the input devices and the output devices of the component of the system and/or the gaming establishment device.

It should be appreciated that the terminology used herein is for the purpose of describing particular aspects only and is not intended to be limiting of the disclosure. For example, the singular forms “a”, “an” and “the” are intended to include the plural forms as well, unless the context clearly indicates otherwise. In another example, the terms “including” and “comprising” and variations thereof, when used in this specification, specify the presence of stated features, steps, operations, elements, and/or components, but do not preclude the presence or addition of one or more other features, steps, operations, elements, components, and/or groups thereof. Additionally, a listing of items does not imply that any or all of the items are mutually exclusive nor does a listing of items imply that any or all of the items are collectively exhaustive of anything or in a particular order, unless expressly specified otherwise. Moreover, as used herein, the term “and/or” includes any and all combinations of one or more of the associated listed items. It should be further appreciated that headings of sections provided in this document and the title are for convenience only, and are not to be taken as limiting the disclosure in any way. Furthermore, unless expressly specified otherwise, devices that are in communication with each other need not be in continuous communication with each other and may communicate directly or indirectly through one or more intermediaries.

Various changes and modifications to the present embodiments described herein will be apparent to those skilled in the art. For example, a description of an embodiment with several components in communication with each other does not imply that all such components are required, or that each of the disclosed components must communicate with every other component. On the contrary a variety of optional components are described to illustrate the wide variety of possible embodiments of the present disclosure. As such, these changes and modifications can be made without departing from the spirit and scope of the present subject matter and without diminishing its intended technical scope. It is therefore intended that such changes and modifications be covered by the appended claims.

1. A system comprising:
a processor; and
a memory device that stores a plurality of instructions that, when executed by the processor following a user providing identifying information in association with an attempted gaming establishment retail transaction occurring at a point-of-sale terminal of a gaming establishment retail system, cause the processor to:
receive the identifying information provided by the user in association with the attempted gaming establishment retail transaction, wherein the identifying information comprises user identifying information associated with the user prior to the attempted gaming establishment retail transaction,
determine if the user is associated with any gaming establishment retail accounts, and
responsive to the user not being associated with any gaming establishment retail accounts, automatically and independent of the user providing any additional identifying information:
create a gaming establishment retail account associated with the user, wherein the creation of the gaming establishment retail account is at least partially based on the identifying information provided by the user in association with the attempted gaming establishment retail transaction, and
communicate a request to transfer an amount of funds to the created gaming establishment retail account.

2. The system of claim 1, wherein the attempted gaming establishment retail transaction comprises a first attempted gaming establishment retail transaction by the user in association with the gaming establishment retail system.

3. The system of claim 1, wherein the memory device stores a plurality of further instructions that, when executed by the processor in association with the attempted gaming establishment retail transaction, cause the processor to:
request additional identifying information associated with the user from a gaming establishment component that maintains another gaming establishment account, and
responsive to a receipt of the additional identifying information associated with the user from the gaming establishment component, modify, based on the additional identifying information, an attribute of the created gaming establishment retail account.

4. The system of claim 3, wherein the other gaming establishment account comprises a cashless wagering account and the additional identifying information was provided by the user in association with the creation of the cashless wagering account.

5. The system of claim 3, wherein the other gaming establishment account comprises a gaming establishment patron management system account and the additional identifying information was provided by the user in association with the creation of the gaming establishment patron management system account.

6. The system of claim 1, wherein the memory device stores a plurality of further instructions that, when executed by the processor after a completion of the attempted gaming establishment retail transaction, cause the processor to:
request additional identifying information associated with the user from a gaming establishment component that maintains another gaming establishment account, and
responsive to a receipt of the additional identifying information associated with the user from the gaming establishment component, modify, based on the additional identifying information, an attribute of the created gaming establishment retail account.

7. The system of claim 6, wherein the other gaming establishment account comprises a cashless wagering account and the additional identifying information was provided by the user in association with the creation of the cashless wagering account.

8. The system of claim 6, wherein the other gaming establishment account comprises a gaming establishment patron management system account and the additional identifying information was provided by the user in association with the creation of the gaming establishment patron management system account.

9. The system of claim 1, wherein the amount of funds are requested to be transferred to the created gaming establishment retail account from a non-gaming establishment account.

10. A system comprising:
a processor; and
a memory device that stores a plurality of instructions that, when executed by the processor responsive to a first attempted gaming establishment retail transaction, cause the processor to:
determine if a user associated with the first attempted gaming establishment retail transaction is associated with any gaming establishment retail accounts, and
responsive to the determination being that the user is not associated with any gaming establishment retail accounts:
automatically create a gaming establishment retail account, and prior to a second attempted gaming establishment retail transaction associated with the user:
request identifying information associated with the user from a gaming establishment component that maintains another gaming establishment account, the identifying information being at least partially inputted by the user in association with a creation of the other gaming establishment account, and
responsive to a receipt of the identifying information associated with the user from the gaming establishment component that maintains the other gaming establishment account, modify, based on the identifying information associated with the user, an attribute of the created gaming establishment retail account.

11. The system of claim 10, wherein the first attempted gaming establishment retail transaction comprises a return transaction.

12. A method of operating a system, the method comprising:
following a user providing identifying information in association with an attempted gaming establishment retail transaction occurring at a point-of-sale terminal of a gaming establishment retail system:
receiving the identifying information provided by the user in association with the attempted gaming establishment retail transaction, wherein the identifying information comprises user identifying information associated with the user prior to the attempted gaming establishment retail transaction,
determining, by a processor, if the user is associated with any gaming establishment retail accounts, and
responsive to the user not being associated with any gaming establishment retail accounts, automatically and independent of the user providing any additional identifying information:
creating, by the processor, a gaming establishment retail account associated with the user, wherein the creation of the gaming establishment retail account is at least partially based on the identifying information provided by the user in association with the attempted gaming establishment retail transaction, and
communicating a request to transfer an amount of funds to the created gaming establishment retail account.

13. The method of claim 12, wherein the attempted gaming establishment retail transaction comprises a first attempted gaming establishment retail transaction by the user in association with the gaming establishment retail system.

14. The method of claim 12, further comprising, in association with the attempted gaming establishment retail transaction:
requesting additional identifying information associated with the user from a gaming establishment component that maintains another gaming establishment account, and
responsive to a receipt of the additional identifying information associated with the user from the gaming establishment component, modifying, by the processor and based on the additional identifying information, an attribute of the created gaming establishment retail account.

15. The method of claim 14, wherein the other gaming establishment account comprises a cashless wagering account and the additional identifying information was provided by the user in association with the creation of the cashless wagering account.

16. The method of claim 14, wherein the other gaming establishment account comprises a gaming establishment patron management system account and the additional identifying information was provided by the user in association with the creation of the gaming establishment patron management system account.

17. The method of claim 12, further comprising, after a completion of the attempted gaming establishment retail transaction:
requesting additional identifying information associated with the user from a gaming establishment component that maintains another gaming establishment account, and
responsive to a receipt of the additional identifying information associated with the user from the gaming establishment component, modifying, by the processor and based on the additional identifying information, an attribute of the created gaming establishment retail account.

18. The method of claim 17, wherein the other gaming establishment account comprises a cashless wagering account and the additional identifying information was provided by the user in association with the creation of the cashless wagering account.

19. The method of claim 17, wherein the other gaming establishment account comprises a gaming establishment patron management system account and the additional identifying information was provided by the user in association with the creation of the gaming establishment patron management system account.

20. The method of claim 12, wherein the amount of funds are requested to be transferred to the created gaming establishment retail account from a non-gaming establishment account.
